(19) United States
(12) Patent Application Publication
(10) Pub. No.: US 2005/0175528 A1
(43) Pub. Date: Aug. 11, 2005

(54) Method for producing chlorine from hydrogen chloride

(75) Inventors: Christian Walsdorff, Ludwigshafen (DE); Martin Fiene, Niederkirchen (DE); Markus Weber, Ludwigshafen (DE); Eckhard Strofer, Mannheim (DE); Klaus Harth, Altleiningen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/511,604

(22) PCT Filed: May 13, 2003
(86) PCT No.: PCT/EP03/04970

(51) Int. Cl. C01B 7/04

(52) U.S. Cl. 423/507

(57) ABSTRACT

The present invention relates to a process for the continuous preparation of chlorine by reaction of hydrogen chloride with oxygen in the presence of a heterogeneous catalyst, in which the conversion of hydrogen chloride in a single pass through the reactor is restricted to from 15 to 90%.

The present invention relates to a process for the continuous preparation of chlorine by reaction of hydrogen chloride with oxygen in the presence of a heterogeneous catalyst and with the hydrogen chloride conversion being restricted.

The catalytic oxidation of hydrogen chloride to chlorine is known as the Deacon process.

GB-A-1,046,313 discloses catalysts for the Deacon process which comprise a ruthenium compound on a support compound. It is stated that the thermodynamic equilibrium of the reaction can be achieved at relatively low temperatures when such catalysts are used. A description is also given of the preparation of chlorine using air as oxygen source, with the reaction mixture being conveyed over the catalyst in a single pass and subsequently being worked up. Disadvantages of this process are the relatively low maximum yields of chlorine based on hydrogen chloride which can be achieved in a single pass and the high offgas flows when using air as oxygen source, which also make recirculation of the unreacted oxygen difficult.

EP-A-233 773 discloses a process for preparing chlorine by the Deacon process using a catalyst comprising chromium oxide. In this process, hydrogen chloride which is not reacted in the single pass is absorbed as dilute hydrochloric acid and discharged from the process. The oxygen which is not reacted in the single pass is, after a purge stream has been separated off, recirculated to the reactor. A disadvantage of this process is the formation of considerable amounts of dilute hydrochloric acid which are lost to chlorine production.

EP-A-1 099 666 discloses a process for preparing chlorine by the Deacon process in which hydrogen chloride is firstly separated off from the product gas stream as aqueous hydrochloric acid and is subsequently separated off again from the hydrochloric acid by distillation and recirculated to the reaction section. Appropriate choice of distillation conditions and use of a second distillation column makes it possible for all of the hydrogen chloride to be recovered from the hydrochloric acid, so that virtually no hydrochloric acid is obtained as by-product.

However, the catalysts in the abovementioned processes are deactivated rapidly, since they are operated at high conversions.

It is an object of the present invention to remedy the abovementioned disadvantages.

We have found that this object is achieved by a new and improved process for the continuous preparation of chlorine by reaction of hydrogen chloride with oxygen in the presence of a heterogeneous catalyst, wherein the conversion of hydrogen chloride in a single pass through the reactor is restricted to from 15 to 90%.

The process of the present invention can be carried out as follows:

The process of the present invention can be carried out adiabatically or preferably isothermally or approximately isothermally, batchwise or preferably continuously as a fluidized-bed or fixed-bed process, preferably as a fixed-bed process, particularly preferably in shell-and-tube reactors, over heterogeneous catalysts at reactor temperatures of from 180 to 500° C., preferably from 200 to 400° C., particularly preferably from 220 to 350° C., and a pressure of from 1 to 20 bar, preferably from 1.1 to 10 bar, particularly preferably from 1.2 to 5 bar and in particular from 1.5 to 3 bar.

In an isothermal or approximately isothermal process, it is also possible to use a plurality, i.e. from 2 to 10, preferably from 2 to 6, particularly preferably from 2 to 5, in particular from 2 to 3, reactors connected in series with additional intermediate cooling. The oxygen can either all be added together with the hydrogen chloride upstream of the first reactor or its introduction can be distributed over the various reactors. This connection in series of individual reactors can also be combined in one reactor.

A preferred embodiment comprises using a structured catalyst bed in which the catalyst activity increases in the direction of flow. Such a structuring of the catalyst bed can be achieved by differing impregnation of the catalyst supports with active composition or by differing dilution of the catalyst with an inert material. Inert materials which can be used are, for example, rings, cylinders or spheres of steatite, ceramic, glass, graphite or stainless steel. In the case of the preferred use of shaped catalyst bodies, the inert material preferably has similar external dimensions.

Suitable shaped catalyst bodies are in general any shapes, preferably pellets, rings, cylinders, stars, wagon wheels or spheres, particularly preferably rings, cylinders or star extrudates.

Suitable heterogeneous catalysts are doped or undoped ruthenium catalysts or copper catalysts on support materials, preferably doped ruthenium catalysts. Examples of suitable support materials are silicon dioxide, graphite, titanium dioxide having a rutile or anatase structure, aluminum oxide or mixtures thereof, preferably titanium dioxide, aluminum oxide or mixtures thereof, particularly preferably γ-, δ- or α-aluminum oxide or mixtures thereof.

The supported copper or preferably ruthenium catalysts can be obtained, for example, by impregnation of the support material with aqueous solutions of CuCl₂ or RuCl₃ and, if desired, a promoter for doping, preferably in the form its chloride. Shaping of the catalyst can be carried out after or preferably before impregnation of the support material.

Promoters suitable for doping are, for example, alkali metals such as lithium, sodium, potassium, rubidium and cesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

The shaped bodies can subsequently be dried at from 100 to 400° C., preferably from 100 to 300° C., for example under a nitrogen, argon or air atmosphere and, if appropriate, calcined. Drying can be carried out in one or more stages at different temperatures. Drying is preferably carried out in two stages; for example, the shaped bodies are firstly dried at from 100 to 150° C. and subsequently calcined at from 200 to 400° C.

When using supported ruthenium catalysts, the oxygen should preferably be present in the reactor in substoichiometric, stoichiometric or slightly superstoichiometric amounts, and when using supported copper catalysts, it should be present in the reactor in a stoichiometric excess.

The conversion of hydrogen chloride in a single pass can be restricted to from 15 to 90%, preferably from 20 to 80%, particularly preferably from 25 to 70%, in particular from 30 to 60%. The hydrogen chloride which is not reacted in the single pass through the reactor can be separated off and partly or wholly recirculated to the reaction section. The ratio of hydrogen chloride to oxygen (O₂) at the inlet to the reactor is generally in the range from 1:1 to 20:1, preferably from 2:1 to 8:1, particularly preferably from 3:1 to 5:1.

The gradual deactivation of the catalyst can be reduced by increasing the proportion of recirculated hydrogen chloride (increasing the recycle ratio); this increases the operating life of the catalyst.

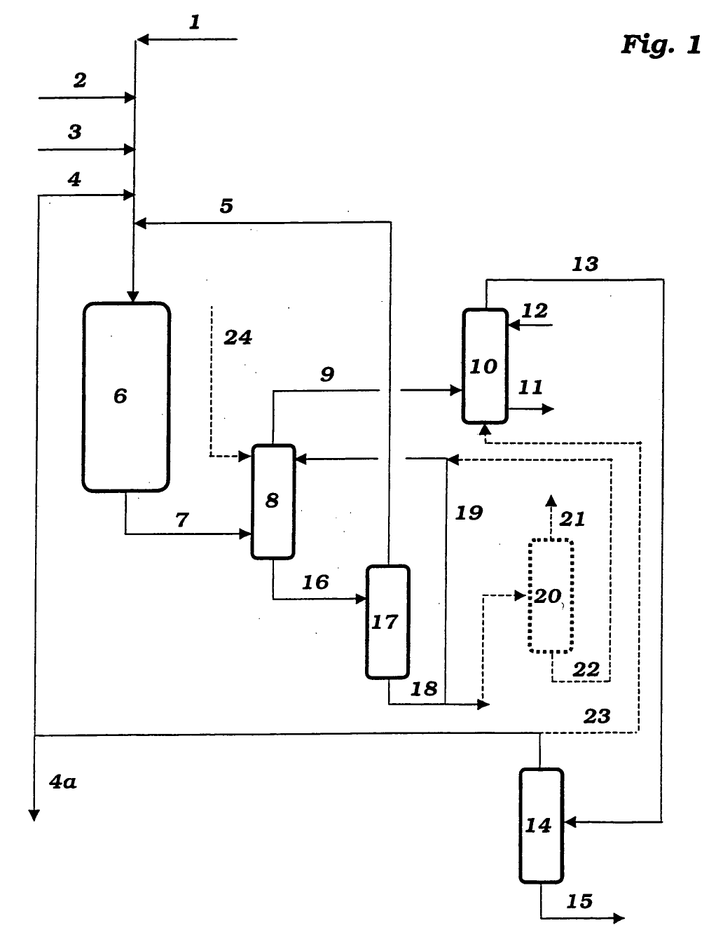

An illustrative flow diagram of the process of the present invention is shown, purely by way of example, in FIG. 1 and is described in the following legend:

Legend:

1. Nitrogen; only for start-up, shutdown or for providing inert conditions in the process

2. Oxygen

3. Hydrogen chloride

4. Circulated gas (essentially oxygen)

4a. Purge stream from the circulated gas

5. Hydrogen chloride

6. Reactor (preferably shell-and-tube reactor, one or more stages, possibly with intermediate introduction of oxygen)

7. Gaseous product mixture (essentially chlorine, water vapor, oxygen and hydrogen chloride)

8. Separation stage for separating off hydrogen chloride and water by any method with which those skilled in the art are familiar (preferably scrubbing tower, possibly with cooler)

9. Scrubbed product gas (essentially chlorine, oxygen, residual water and possibly small amounts of hydrogen chloride)

10. Drying (preferably drying tower, possibly multistage and with heat exchangers for cooling)

11. Dilute sulfuric acid (can optionally be recirculated to the process after having been concentrated)

12. Concentrated sulfuric acid

13. Essentially oxygen and chlorine

14. Chlorine condensation stage

15. Liquid chlorine (optionally to further distillation)

16. Hydrochloric acid

17. Hydrochloric acid distillation

18. Dilute hydrochloric acid (azeotropic composition)

19. Dilute hydrochloric acid (substream)

20. Optional low-pressure distillation of the dilute hydrochloric acid

21. Water vapor

22. Dilute hydrochloric acid

23. Substream: circulated gas (essentially oxygen) for stripping chlorine from the sulfuric acid

24. Optional: water

1: A process for the continuous preparation of chlorine by reaction of hydrogen chloride with oxygen in the presence of a heterogeneous catalyst, wherein the conversion of hydrogen chloride in a single pass through the reactor is restricted to from 15 to 90%.

2: The process as claimed in claim 1, wherein some or all of the unreacted hydrogen chloride is recirculated.

3: The process as claimed in claim 1, wherein the hydrogen chloride conversion in a single pass is restricted to from 20 to 80%.

4: The process as claimed in claim 1, wherein the hydrogen chloride conversion in a single pass is restricted to from 25 to 70%.

5: The process as claimed in claim 1, wherein the hydrogen chloride conversion in a single pass is restricted to from 30 to 60%.

6: The process as claimed in claim 1, wherein the heterogeneous catalyst used is a doped or undoped supported ruthenium catalyst.

7: The process as claimed in claim 1, wherein the proportion of recirculated hydrogen chloride is gradually increased during the time of operation of the catalyst.

8: The process as claimed in claim 1, wherein the reaction is carried out using from 2 to 10 reactors connected in series.

9: The process as claimed in claim 8, wherein the introduction of oxygen is divided over a plurality of reactors.
